(19) United States
(12) Patent Application Publication
(10) Pub. No.: US 2011/0019329 A1
(43) Pub. Date: Jan. 27, 2011

(54) CONTROLLABLE POWER RELAY

(76) Inventors: Benjamin Hayumi, Jerusalem (IL); Roi Birger, Haifa (IL)

Correspondence Address: EITAN MEHULAL LAW GROUP, 10 Abba Eban Blvd. PO Box 2081, Herzlia, 46120, IL

(21) Appl. No.: 12/735,462

(22) PCT Filed: Jan. 20, 2009
(86) PCT No.: PCT/IL2009/000078

§ 371 Date: Oct. 6, 2010

Related U.S. Application Data
(60) Provisional application No. 61/022,345, filed on Jan. 20, 2008.

(51) Int. Cl. H01H 47/00

(52) U.S. Cl. 361/160

(57) ABSTRACT

Device, system and method of controllable power relay. For example, a power relay device, to controllably relay an electric power signal to a first device based on a control signal from a second device, may include a power input to receive an input electric signal; a power output; a control-signal receiver to receive the control signal from the second device, while the power relay device is galvanically separated from the second device; and a control module to controllably output the electric signal via the power output based on the control signal. Other embodiments are described and claimed.

### CROSS REFERENCE

This application claims the benefit of and priority from U.S. Provisional Patent application 61/022,345, entitled “Power on cable device, system and method”, filed Jan. 20, 2008, the entire disclosure of which is incorporated herein by reference.

### FIELD

Some embodiments relate generally to the field of power control and, more particularly, to controllably relaying an electric power signal to a first device based on a control instruction from a second device.

### BACKGROUND

Some systems may include at least one first device required to manage and/or control the operation of at least one second device, which may be separated and/or remote from the first device.

A computing system, for example, may include one or more first computing devices, e.g., one or more user consoles, which may control and/or access one or more second computing devices, e.g., one or more servers. For example, the users may manage and/or control the servers by controlling electric power supplied to the servers, e.g., in order to power-on, power-off and/or reboot one or more of the servers.

### SUMMARY

Some embodiments include a power relay device to controllably relay an electric power signal to a first device based on a control signal from a second device. The power relay device may include a power input to receive an input electric signal; a power output; a control-signal receiver to receive the control signal from the second device, while the power relay device is galvanically separated from the second device; and a control module to controllably output the electric signal via the power output based on the control signal.

In some embodiments, the control module includes a switch having a first mode, in which the power output is electrically connected to the power input, and a second mode, in which the power output is electrically disconnected from the power input; and a controller to control the operation of the switch based on the control signal.

In some embodiments, the power relay device includes a non-isolated transformer to transform an alternating-current signal of the input electric signal into a direct-current signal provided to the control module.

In some embodiments, the control-signal receiver includes an optical receiver to receive the control signal in the form of an optical signal.

In some embodiments, the optical receiver includes an infrared receiver to receive the control signal in the form of an infrared control signal.

In some embodiments, the control-signal receiver is to receive the control signal via magnetic induction.

In some embodiments, the control signal includes a wireless signal, and the control-signal receiver includes a wireless receiver.

In some embodiments, the power relay device includes a control signal output to output the received control signal to another power relay device.

In some embodiments, the control signal includes identification information identifying one or more intended power relay devices to utilize the control signal.

In some embodiments, the control module is to controllably output the electrical signal based on the control signal, if the power relay device is included in the one or more intended power relay devices.

In some embodiments, the control module is to relay the control signal to the control-signal output.

In some embodiments, the control-signal output includes an infrared transmitter to transmit an infrared signal corresponding to the control signal.

In some embodiments, the control-signal output includes a light emitting diode.

In some embodiments, the power relay device includes a single-input-single-output power relay device having a single power input and a single power output.

In some embodiments, the control signal includes an instruction selected from the group consisting of a power-on instruction, a power-off instruction, and a reboot instruction.

In some embodiments, the control signal includes an indication of an identifier to be assigned to the power relay device.

In some embodiments, the length of the power relay device is less than about 150 mm, the width of the power relay device is less than about 100 mm, and the height of the power relay device is less than about 45 mm.

In some embodiments, the power relay device includes an output port, wherein the control module is to receive a request signal from the second device via the control-signal receiver, and, in response to the request signal to output response information.

Some embodiments include a power relay device to controllably relay electric power, the power relay device including a power input to receive an input electric signal, wherein the input electric signal carries thereon control data; a power output; and a control module to controllably output the electric signal via the power output based on the control data.

In some embodiments, the control module includes a switch having a first mode, in which the power output is electrically connected to the power input, and a second mode, in which the power output is electrically disconnected from the power input; a detector to detect the control data from the input electric signal; and a controller to control the operation of the switch based on the detected control data.

In some embodiments, the control data includes an instruction selected from the group consisting of a power-on instruction, a power-off instruction, and a reboot instruction.

Some embodiments include a system including a power relay device including: a power input to receive an input electric signal from a power source; a power output connectable to a destination device; a control-signal receiver to receive a control signal from a power management device, while the power relay device is galvanically separated from the power management device; and a control module to controllably output the electric signal via the power output based on the control signal.

In some embodiments, the system includes a connector interface to transfer the control signal from the power management device to the control-signal receiver.

In some embodiments, the power relay device includes a non-isolated transformer to transform the input electric signal into a direct-current signal provided to the control module.

In some embodiments, the control-signal receiver includes an optical receiver to receive the control signal in the form of an optical signal.

In some embodiments, the power relay device includes a control signal output to output the received control signal.

In some embodiments, the system includes another power relay device including a control-signal receiver to receive the outputted control signal.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system including at least one power relay device, in accordance with some demonstrative embodiments.

FIG. 2 is a schematic block diagram illustration of a power relay device, in accordance with some demonstrative embodiments.

FIG. 3 is a schematic block diagram illustration of a power-relay scheme including a plurality of cascaded power relay devices, in accordance with some demonstrative embodiments.

FIG. 4 is a schematic block diagram illustration of a power relay device, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a blade server chassis, a server blade, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, devices and/or networks operating in accordance with any suitable wired or wireless Ethernet standards, e.g., the existing IEEE 802.3 standards and/or future versions and/or derivatives and/or LTE of the above standards, devices and/or networks operating in accordance with any suitable Internet Protocol (IP), for example, IP version 4 (IPv4), IP version 6 (IPv6), and/or nay future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS),

Wi-Fi, Wi-Max, ZigBee, Global System for Mobile communication (GSM), 2G, 2.5G, 3G, 3.5G, or the like. Some embodiments may be used in various other devices, systems and/or networks.

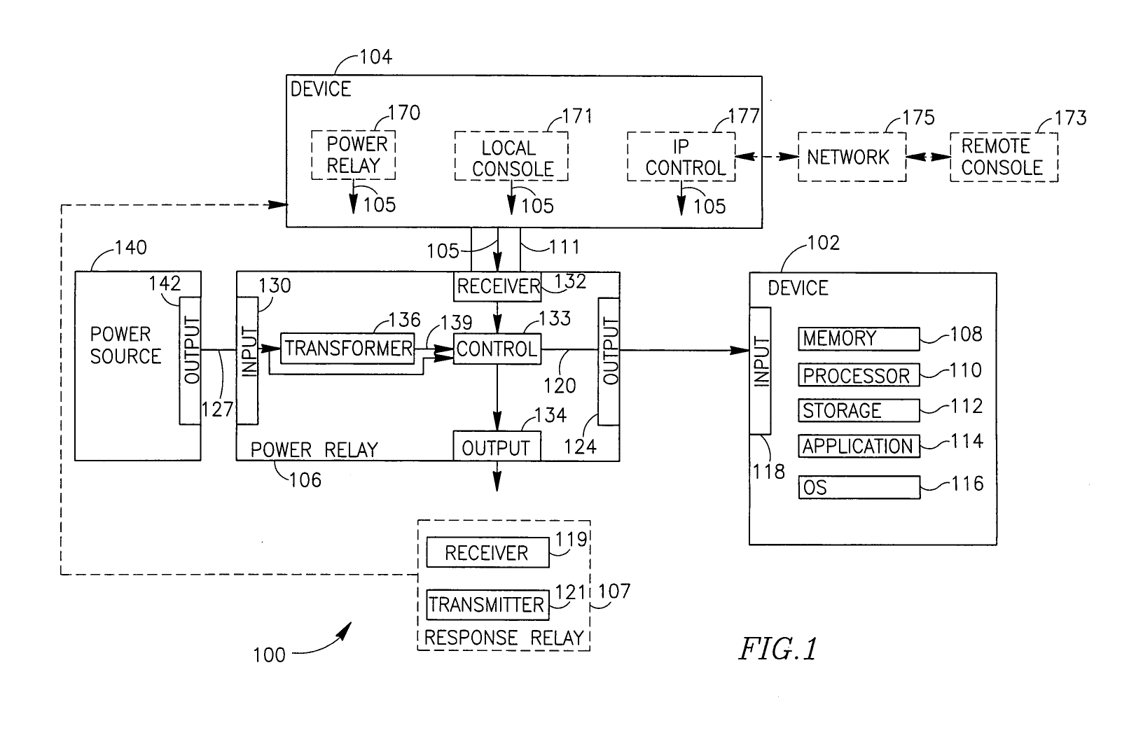

Reference is now made to FIG. 1, which schematically illustrates a block diagram of a system 100 in accordance with some demonstrative embodiments.

In some embodiments, system 100 may include at least one power relay device 106 to controllably provide power to at least one first device 102 based on at least one control signal 105 received from at least one second device 104 (“the control-signal provider”), e.g., as described in detail below.

In some embodiments, power relay device 106 may include a single-input-single-output (SISO) power relay device having a single power input and a single power output, e.g., as described below. However, it will be appreciated that other embodiments may include a single-input-multi-output (SIMO) power relay device including a single power input and a plurality of power outputs, a multi-input-single-output (MISO) power relay device including a plurality of power inputs and a single power output, or a multi-input-multi-output (MIMO) power relay device including a plurality of power inputs and a plurality of power outputs.

In some embodiments, device 102 may include any suitable device, module and/or system configured to utilize an external power supply. In one embodiment, device 102 may include any suitable computer, server, computing system, computing device, and the like. For example, device 102 may include, for example, a PC, a desktop computer, a server computer, a blade server, a rack-mount server, an application server, a communication server, a database server, a proxy server, a web server, a wireless communication device, a wireless Access Point (AP), or the like.

In one embodiment, device 102 may include, for example, a memory 108, storage 112, a processor 110 and/or any other suitable software and/or hardware components.

Processor 110 may include, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific integrated circuit (ASIC), or any other suitable multi-purpose or specific processor or controller. Processor 110 may execute instructions and process data, for example, of an operating system (OS) 114 and/or one or more software applications 114.

Memory 108 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Memory 108 may be coupled to processor 110 by a system bus or other suitable interconnect.

Storage 112 may include, for example, a hard disk drive, a floppy disk drive, a compact disk (CD) drive, a CD-ROM drive, a digital versatile disk (DVD) drive, or other suitable removable or non-removable storage units. Memory 108 and/or storage 112 may, for example, store data processed by device 102.

In some embodiments, device 102 may include a power input 118 to receive electric power signals.

In some embodiments, power relay device 106 may include a power output 124 connectable to power input 118 using any suitable connection and/or interface. In one embodiment, output 124 may be directly connectable to input 118. In one example, input 118 may include a suitable power plug (male) connector, and output 124 may include a suitable power socket (female) connector configured to be connected to the power plug. In another example, input 118 may include a suitable power socket (female) connector, and output 124 may include a suitable power plug (male) connector configured to be connected to the power socket. In other embodiments, output 124 may be connectable to input 118 via any suitable interfacing connection, e.g., as suitable power cord or cable.

In some embodiments, power relay device 106 may include a power input 130 to receive an input electric signal 127 from any suitable power source 140. Power input 130 may be connectable to a power output 142 of power source 140 using any suitable connection and/or interface. In one embodiment, input 130 may be directly connectable to output 142. In one example, output 142 may include a suitable power plug (male) connector, and input 130 may include a suitable power socket (female) connector configured to be connected to the power plug. In another example, output 142 may include a suitable power socket (female) connector, and input 130 may include a suitable power plug (male) connector configured to be connected to the power socket. In other embodiments, input 130 may be connectable to output 142 via any suitable interfacing connection, e.g., as suitable power cord or cable.

In some embodiments, control signal 105 may include an instruction selected from a predefined set of power-control instructions. For example, the set of power-control instructions may include a power-on instruction to power on (“switch on”) device 102, e.g., by providing electric power to device 102 via input 118; a power-off instruction to power off (“switch off”) device 102, e.g., by not providing electric power to device 102 via input 118; a reboot instruction to reboot device 102, e.g., by powering-off device 102 and powering device 102 back on after a predefined time period; and/or any other suitable power-control instruction. In other embodiments, control signal may include any other suitable control signal to control the electric power provided to device 102.

In some embodiments, device 104 may include any suitable device or module capable of providing control signal 105 to power relay device 106. In one embodiment, device 104 may include a device capable of generating signal 105. In one example, device 105 may include a computing device (“local console”) 171 capable of generating signal 105, e.g., based on an instruction from a user of local console 171. For example, the user of console 171 may use a suitable user interface to instruct console 171 to power-on, power-off or reboot device 102, and console 171 may generate control signal 105 responsive to the instruction received from the user. In another example, device 104 may include a suitable control device 177, for example, an Internet-Protocol (IP) control device to generate control signal 105 based on instructions received from a computing device (“remote console”) 173 via a communication network 175, e.g., an Ethernet communication network and/or the Internet. For example, the user of remote console 173 may use a suitable user interface to communicate to control device 177, via communication network 175, an instruction to power-on, power-off or reboot device 102, and control device 177 may generate control signal 105 responsive to the instruction received from the user. In another embodiment, device 104 may include another power relay device 179, e.g., similar to power relay device 106. For example, power relay device 179 may receive signal 105 from another control provider device and relay signal 105 to power relay device 106, e.g., as described below.

In some embodiments, power relay device 106 may include a control-signal receiver 132 to receive control signal 105 from device 104, while power relay device 106 is galvanically separated from device 104.

The phrase “galvanically separated” as used herein with relation to first and second elements refers to the first and second elements not being galvanically coupled to each other; the first and second elements not being connected via a conducting material; and/or the first and second elements being electrically separated from one another; such that, for example, substantially no compensation currents flow between the first and second elements, e.g., when the first and second elements have different ground potentials. For example, power relay device 106 may not be galvanically coupled to device 104; power relay device 106 may not be connected to device 104 via a conducting material; and/or power relay device 106 may be electrically separated from device 104; such that, for example, substantially no compensation currents flow between power relay device 106 and device 104, e.g., when devices 104 and 106 have different ground potentials.

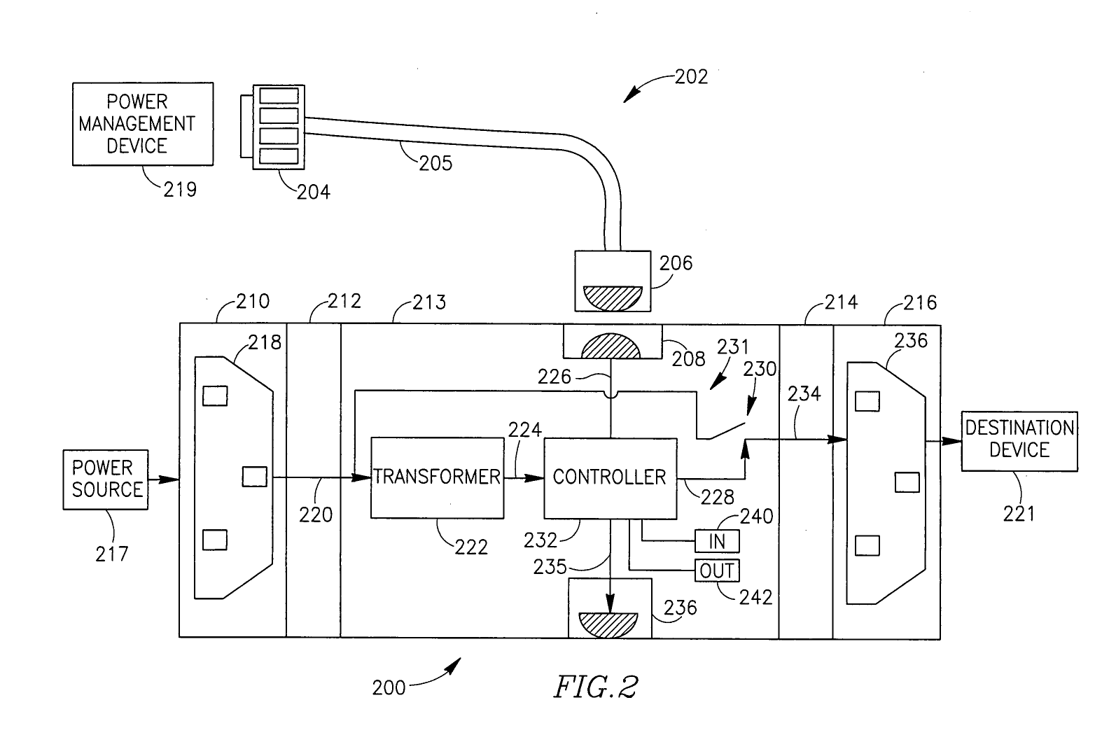

In some embodiments, control-signal receiver 132 may include an optical receiver to receive control signal 105 in the form of an optical signal. In one embodiment, control-signal receiver 132 includes an infrared (IR) receiver to receive control signal 105 in the form of an IR control signal, e.g., as described below with reference to FIG. 2. For example, power relay device 106 may be connected to device 104 via a connector interface 111, e.g., as described below with reference to FIG. 2.

In some embodiments, control-signal receiver 132 may include any suitable magnetic induction receiver to receive signal 105 via magnetic induction.

In some embodiments, control-signal receiver 132 may include any suitable wireless-communication receiver to receive signal 105 in the form of a wireless-communication signal.

For example, device 104 may include any suitable wireless transmitter, e.g., a suitable Radio-Frequency (RF) transmitter, to transmit wireless signals including power-control signal 105; and control-signal receiver 132 may include any suitable wireless receiver, e.g., a RF receiver, to receive signal 105. The RF transmitter and/or RF receiver may include any suitable transmitter and receiver, e.g., in accordance with the IEEE 802.11, 802.11a, 802.11b, 802.11e, 802.11g, 802.11h, 802.11i, 802.11n, 802.16, 802.16d, 802.16e standards, and the like.

In some embodiments, power relay device 106 may include a control module 133 to controllably output an electric power signal 120, via power output 124 based on power-control signal 105, e.g., as described below.

In some embodiments, input electric signal 127 may include an Alternating-Current (AC) signal, and power relay device 106 may include a transformer 136 to transform input electric signal 127 into a Direct-Current (DC) signal provided to control module 133.

In some embodiments, transformer 136 may include a non-isolated transformer. The use of a non-isolated transformer in power relay device 106 may be allowed, e.g., without affecting the operation of device 104 and/or power relay device 106, for example, since power relay device 106 is galvanically separated from device 104.

In some embodiments, a non-isolated transformer may have relatively small dimensions compared to the dimensions of an isolated transformer, for example, the height, width and/or length of the non-isolated transformer may be about 20 percent less than the height, width and/or length of an isolated transformer having the same functionality. As a result, the utilizing non-isolated transformer 136 may enable a relatively large reduction in the dimensions of power relay device 106.

In some embodiments, power relay device 106 may be implemented in the form of a power cable (“power over cable relay device”) having dimensions similar to the dimensions of a conventional power cable. In one embodiment, power relay device 106 may be implemented in the form of a generally elongated cable-like device integrally including output 124 in the form of a power plug or socket connector and/or input 130 in the form of a power plug or socket connector. The cable-like device 106 may have external dimensions similar to external dimensions of a conventional power cable. For example, power relay device 106 may have a length of between about 30 millimeter (mm) and about 150 mm, for example, between about 40 mm and 100 mm; a width of between about 30 mm and 100 mm, for example, between about 35 mm and 40 mm; and/or a height of between about 20 mm and 45 mm, for example, between about 25 mm and 32 mm. In other embodiments, device 106 may have any other dimensions.

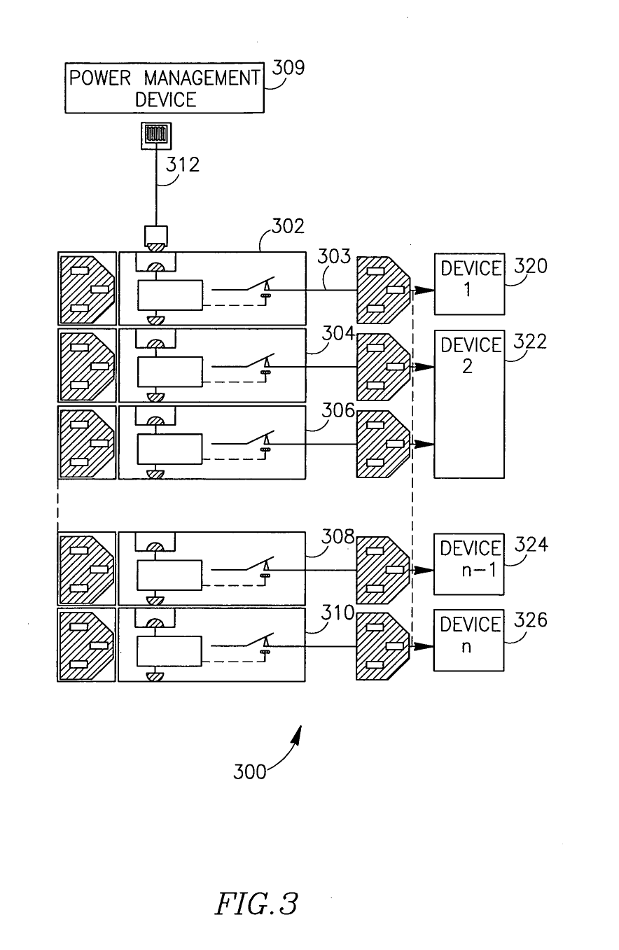

In some embodiments, power relay device 106 may be capable of being implemented in a system including one or more other power relay devices to relay power to one or more other devices. In one embodiment, power relay device 106 may be may be cascaded with the one or more other power relay devices. For example, power relay device 106 may be capable of relaying power-control signal 105 to the one or more other power relay devices, e.g., serially, as described below with reference to FIG. 3. In other embodiments, power relay device 106 may be implemented as part of any other suitable, e.g., serial and/or parallel, power relay scheme.

In some embodiments, power relay device 106 may include a control-signal output 134 to output control signal 105 to another power relay device, e.g., as described below.

In some embodiments, control module 133 may relay control signal 105 to control signal output 134, e.g., as described below.

In some embodiments, power-control signal 105 may include an indication of an identifier to be assigned to power relay device 106, e.g., as described below.

In some embodiments, control-signal output 134 may include an IR transmitter to transmit an IR signal corresponding to control signal 105, e.g., as described below. For example, output 134 may include an IR Light-Emitting-Diode (LED). In other embodiments, control-signal output 134 may include any other suitable output or transmitter to provide the relayed control signal to another power relay device.

In some embodiments, control signal 105 may be generated according to any suitable control protocol.

In some embodiments, control signal 105 may include, for example, an instruction portion representing an instruction to be performed based on control signal; and an identifier portion to identify a power relay device to perform the instruction. For example, if control signal 105 includes a power-on instruction, then the instruction portion of control signal 105 may have a first value identifying a “power-on” instruction, and the identifier portion may include an identifier value to identify a power-relay device to perform the power-on instruction. If control signal 105 includes a “power-off” instruction, then the instruction portion of control signal 105 may have a second value identifying a “power-off” instruction, and the identifier portion may include an identifier value to identify a power-relay device to perform the power-off instruction. If control signal 105 includes a reboot instruction, then the instruction portion of control signal 105 may have a third value identifying a “reboot” instruction, the identifier portion may include an identifier value to identify a power-relay device to perform the reboot instruction. Control signal 105 may also include a time value representing a time period between performing the powering-off and the powering-on operations of the reboot operation.

In some embodiments, control signal 105 may include a re-identification instruction to assign a new identifier to a power relay device. For example, the instruction portion of control signal 105 may have a fourth value identifying a re-identification instruction, the identifier portion may include an identifier value to identify a power-relay device to be re-identified. Control signal 105 may also include the new identifier to be assigned to the power relay device. Upon receiving control signal 105 identifying power relay device 106, control module 133 may assign the new identifier to power relay device 106.

In some embodiments, control signal 105 may include a serial-identification instruction to assign identifiers to a series of power relay devices. For example, the instruction portion of control signal 105 may have a fifth value identifying a serial-identification instruction, the identifier portion may include an identifier value, denoted “x”, to be assigned to a first power relay device of the series of power relay devices. Upon receiving control signal 105, control module 133 of the first power relay device 106 may assign to the device the identifier x; control module 133 of a successive power relay device 106 may assign to the device the identifier x+1, and so on.

In some embodiments, control signal 105 may include any suitable additional or alternative instruction.

In some embodiments, power relay device 106 may be capable of performing bi-directional communication with device 104, e.g., in the sense that controller 133 may be capable of providing suitable information back to device 104. In one embodiment, control signal 105 may include an instruction to cause controller 133 to provide any suitable predefined data, e.g., data relating to power relay device and/or to the operation of power relay device 106, via output 134. For example, control signal 105 may include a predefined request signal indicating to controller 133 of suitable information required from controller 133. The request signal may include, for example, a status request from controller 133 to provide status information regarding the status of power relay device 106, e.g., indicating whether or not power relay device 106 is relaying electric power to device 102. The request signal may include a request for any other suitable information, for example, a power measurement relating to signals 120 and/or 127, a log of previous measurements and/or operations performed by power relay device 106, and the like. In response to the request signal, controller 133 may transmit a response signal including the requested data, e.g., via output 134. The response signal may be addressed, for example, to any suitable device 107 (“the response relay device”) capable of receiving the response signal, and providing the response information included in the response signal back to device 104. In one example, device 107 may be connected directly to output 134. In another example, output 134 may be connected to another power relay device, for example, as part of a cascade scheme as described below with reference to FIG. 3. According to this example, device may be connected 107 to the output of any suitable power relay device in the cascade scheme, for example, the last power relay device in the cascade scheme, e.g., to the output of power relay device 310 (FIG. 3). Device 107 may include, for example, a receiver 119, e.g., similar to receiver 132, to receive the response signal; and any suitable transmitter 121 to transmit to device 104 the response information included in the response signal.

In some embodiments, control module 133 may controllably output electric signal 120 to device 102, e.g., based on control signal 105, for example, if power relay device 106 is included in the one or more intended power relay devices. For example, control module 133 may cause power relay device 106 to output signal 120, e.g., if control signal includes a power-on instruction and the identifier of control relay device 106. Control module 133 may cause power relay device 106 to prevent the output of signal 120, e.g., if control signal includes a power-off instruction and the identifier of control relay device 106. Control module 133 may cause power relay device 106 to prevent the output of signal 120 and to output signal 120 after the reboot time period, e.g., if control signal includes a power-on instruction, and the identifier of control relay device 106.

In some embodiments, power relay device 106 may be efficiently and/or easily implemented to provide power control to one or more devices. For example, a single power relay device 106 may be used to provide power control to a single destination device, two power relay devices 106 may be cascaded to provide power control to two respective destination devices, and so one, e.g., such that exactly l power relay devices 106 may be used to provide power control to l respective destination devices. Accordingly, a user may purchase and/or use exactly the required number of power relay devices 106. This is in contrast to some conventional power switches having a predefined configuration, e.g., including a predefined number of power outputs, which may differ from the specific implementation, required by the user.

In some embodiments, power relay device 106 may provide a one-to-one redundancy level. For example, if power redundancy is to be provided to a destination device, then two or more power relay devices 106 may be used to connect the destination device to two or more power sources, thereby to provide the required redundancy level. Such on-to-one redundancy level may be in contrast to the redundancy level provided by conventional power switches. For example, a conventional power switch may include a predefined number m of power inputs, which may be greater than the required redundancy level.

In some embodiments, a plurality of power relay devices 106 may be implemented in a mixture of redundancy and non-redundancy schemes with respect to a plurality of destination devices, for example, by suitably connecting the plurality of power relay devices 106 to one or more power sources and/or to the destination devices, e.g., as described below with reference to FIG. 3.

In some embodiments, the electric power provided via output 124 may be substantially equal to the electric power received by input 130, for example, if power relay device 106 is implemented as a SISO power relay device. This is in contrast to some conventional power switches, which may divide an input electric power between a plurality of power outputs, thereby resulting in significantly lower power availability for the destination devices.

Reference is now made to FIG. 2, which schematically illustrates a power relay device 200, in accordance with some demonstrative embodiments. In one embodiment, power relay device 200 may perform the functionality of power relay device 106 (FIG. 1).

In some embodiments, power relay device 200 may controllably relay an electric power signal to a first device based on a control signal from a second device (“the power management device”). For example, power relay device 200 may relay power from a power source 217, e.g., power source 140 (FIG. 1), to a device (“the destination device”) 221, e.g., device 102 (FIG. 1), based on a control signal from a power-management device 219, e.g., device 104 (FIG. 1).

In some embodiments, power relay device 200 may include a power input portion 210 to receive an input electric signal 220. For example, power input portion 210 may include an input connector 218 connectable to an output of power source 217. In one embodiment, power input portion 210 may perform the functionality of power input 130 (FIG. 1), and input connector 218 may include a suitable power connector, e.g., a C14 male power connector or any other suitable connector, connectable to output 142 (FIG. 1) of power source 140 (FIG. 1).

In some embodiments, power relay device 200 may include a power output portion 216 to output electric signal 220 via an electrical line 234. For example, power output portion 216 may include an output connector 236 connectable to an input of destination device 221. In one embodiment, power output portion 216 may perform the functionality of power output 124 (FIG. 1), and output connector 236 may include a suitable power connector, e.g., a C13 female power connector or any other suitable connector, connectable to input 118 (FIG. 1) of device 102 (FIG. 1).

In some embodiments, power relay device 200 may include a control portion 213 to receive electric signal 220 from portion 210 and controllably output electric signal 220 via electric line 234 to portion 216 based on a power-control signal received via a control-signal receiver 208, e.g., as described below.

In some embodiments, power relay device 200 may include an input cable portion 212 connecting between input portion 210 and control portion 213; and/or an output cable portion 214 connecting between control portion 213 and output portion 216. Cable portions 212 and/or 214 may include any suitable power cord or cable to transfer electric signals 220 and/or 234, respectively. For example, cable portions 212 and/or 214 may include a power cable of suitable length, for example, at least ten centimeters (cm), e.g., at least 20 cm, to enable connecting power relay device 200 between power source 217 and destination device 221, which may be separated from one another. In one embodiment, a power relay device 302 (FIG. 3) may include an output cable portion 303 (FIG. 3), as described below with reference to FIG. 3. In other embodiments, power relay device 200 may not include one or more of cable portions 212 and 214, for example, such that input portion 210 may be directly and/or integrally connected to control portion 213; and/or such that control portion 213 may be directly and/or integrally connected to output portion 216.

In some embodiments, control-signal receiver 208 may be configured to receive the control signal from power-management device 219, while power relay device 200 is galvanically separated from power- management device 219, e.g., as described below.

In some embodiments, control-signal receiver 208 may include an optical receiver to receive the control signal in the form of an optical signal, and generate an electric control signal 226 corresponding to the received control signal. In one embodiment, control-signal receiver 208 includes an IR receiver to receive the control signal in the form of an IR control signal, as described below.

In some embodiments, power relay device 200 may be connected to power-management device 219 via a connector interface 202, e.g., including connector interface 111 (FIG. 1). Connector interface 202 may include an input connector 204 connectable to an output of power-management device 219; an optical transmitter 206; and a suitable cable connecting between input connector 204 and optical transmitter 206. Input connector 204 may include any suitable connector configured to be connected to the output of power-management device 219. In one embodiment, input connector 204 may include a serial data connector, e.g., in accordance with the Recommended-Standard 232 (RS232), or any other suitable connector. Cable 205 may include, for example, a RS232 cable, or the like. Optical transmitter 206 may include, for example, an IR LED configured to receive the control signal from input connector 204 via cable 205; and, based on the control signal, to transmit an optical signal to control signal receiver 208. In one embodiment, power relay device 200 may be configured to be connected to transmitter 206 in a manner allowing receiver 208 to receive the optical control signal transmitted by transmitter 206.

In some embodiments, power relay device 200 may include a control module 231 including a controller 232 and a switch 230 to controllably output signal 220 via electric line 234 based on control signal 226, e.g., as described below.

In some embodiments, switch 230 may have a first mode, in which power output portion 216 is electrically connected to power input portion 210, to thereby transfer power signal 220 to output portion 216 via electric line 234; and a second mode, in which power output portion 216 is electrically disconnected from power input portion 210, to thereby prevent the transfer of power signal 220 to output portion 216.

In some embodiments, controller 232 may receive control signal 226, and control the operation of switch 230, e.g., using a signal 228, based on control signal 226.

In some embodiments, control signal 226 may include a “power-on” instruction, a “power-off” instruction, or a “reboot” instruction, e.g., as described above. If, for example, control signal 226 includes the “power-off” instruction, then controller 232 may generate signal 228 to cause switch 230 to switch to the second mode. If control signal 226 includes the “power-on” instruction, then controller 232 may generate signal 228 to cause switch 230 to switch to the first mode. If control signal 226 includes the “reboot” instruction, then controller 232 may generate signal 228 to cause switch 230 to switch to the second mode. Controller 232 may then generate signal 228 to cause switch 230 to switch to the first mode after a suitable time period, e.g., a time period defined by the reboot instruction or a predefined reboot time period.

In some embodiments, switch 230 may be at the first mode by default, such that power output portion 216 is electrically connected to power input portion 210, e.g., unless switch 230 is actively instructed by controller 232 to switch to the second mode.

In some embodiments, power relay device 200 may include a transformer 222 to transform input electric signal 220 into a DC signal provided to controller 232.

In some embodiments, transformer 222 may include a non-isolated transformer. The use of a non-isolated transformer in power relay device 200 may be allowed, e.g., without affecting the operation of the control device, e.g., device 104 (FIG. 1), and/or power relay device 200, for example, since power relay device 200 is galvanically separated from the control device.

In some embodiments, non-isolated transformer 222 may have relatively small dimensions compared to the dimensions of an isolated transformer. As a result, the utilizing of non-isolated transformer 222 may enable a relatively large reduction in the dimensions of power relay device 200.

In some embodiments, power relay device 200 may be implemented in the form of a power cable (“power over cable relay device”) having dimensions similar to the dimensions of a conventional power cable. In one embodiment, power relay device 200 may be implemented in the form of a generally elongated cable-like device integrally including output portion 216 in the form of a power plug or socket connector and/or input portion 210 in the form of a power plug or socket connector. Device 200 may have external dimensions similar to external dimensions of a conventional power cable. For example, power relay device 200 may have a length of between about 30 (mm) and about 150 mm, for example, between about 40 mm and 100 mm; a width of between about 30 mm and 100 mm, for example, between about 35 mm and 40 mm; and/or a height of between about 20 mm and 45 mm, for example, between about 25 mm and 32 mm. In other embodiments, device 200 may have any other dimensions.

In some embodiments, power relay device 200 be capable of being implemented in a system including one or more other power relay devices to relay power to one or more other devices. For example, power relay device 200 may be capable of relaying power-control signal 226 to the one or more other power relay devices, e.g., serially, as described below with reference to FIG. 3.

In some embodiments, power relay device 200 may include a control-signal output 236 to output control signal 226 to another power relay device. Controller 232 may relay control signal 226 to control signal output 236 via a connection 235, e.g., as described below with reference to FIG. 3.

In some embodiments, power-control signal 226 may include an indication of an identifier to be assigned to power relay device 200, e.g., as described herein.

In some embodiments, control-signal output 236 may include an IR transmitter to transmit an IR signal corresponding to control signal 226. For example, output 236 may include an IR LED. In other embodiments, control-signal output 236 may include any other suitable output or transmitter to provide the relayed control signal to another power relay device.

In some embodiments, control signal 226 may include identification information identifying one or more intended power relay devices to utilize control signal 226. Controller 232 may control switch 230 to controllably output signal 220, e.g., based on control signal 226, for example, if power relay device 200 is included in the one or more intended power relay devices.

In some embodiments, power relay device 200 may include one or more indicators to indicate to a user a status of operation of power relay device 200. For example, power relay device 200 may include a “power-in” indicator 240 and/or a “power-out” indicator 242. Controller 232 may controllably activate indicator 240 to indicate whether or not power signal 220 is received via input portion 210. Controller 232 may controllably activate indicator 242 to indicate whether or not power signal 220 is outputted via output portion 216. Indicators 240 and/or 242 may include, for example, suitable LED indicators, e.g., a red LED and a green LED, and the like.

Reference is made to FIG. 3, which schematically illustrates a power-relay scheme 300 including a plurality of cascaded power relay devices, in accordance with some demonstrative embodiments.

In some embodiments, power-relay scheme 300 may include a plurality of cascaded power relay devices to controllably relay electric power to one or more destination devices. For example, scheme 300 may include a plurality of power relay devices to controllably provide power to n destination devices. For example, a power-relay device 302 may controllably provide electric power to a destination device 320, which is assigned with an identifier (ID) of “1”; a power-relay device 304 and a power relay device 306 may both controllably provide, in a redundant manner, electric power to a second destination device 322, which is assigned with an ID of “2”; a power-relay device 308 may controllably provide electric power to an (n−1)-th destination device 324, which is assigned with an ID of “n−1”; and/or a power-relay device 310 may controllably provide electric power to an n-th destination device 326, which is assigned with an ID of “n”.

In some embodiments, power relay devices 302, 304, 306, 308 and/or 310 may perform the functionality of power relay device 200 (FIG. 2).

In some embodiments, one or more of power relay devices 302, 304, 306, 308 and 310 may include an output cable portion 303, e.g., as described above.

In some embodiments, power relay device 302 may be connected to a power-management device 309, e.g., including power management device 219 (FIG. 2), via a connector interface 312, e.g., connector interface 202 (FIG. 2), as described above. Power relay device 302 may receive from power-management device 309 a control signal via connector interface 312, e.g., as described above. Power relay device 302 relay the control signal to power relay device 304, which in turn may relay the control signal to power relay device 306, and so on, e.g., until the control signal is relayed to devices 308 and 310.

In some embodiments, the control protocol may be formatted according to any suitable control protocol, e.g., the control protocol described above with reference to FIG. 1. In on embodiment, power relay devices 302, 304, 306, 308 and 310 may be assigned with the identifier values 1, 2, 2, n−1 and n, respectively. In one example, device 324 may be rebooted, for example, by providing power relay device with a control signal including an instruction portion having a value representing the reboot operation, an identifier portion having the value “n−1”, and a time value representing the reboot period. Accordingly, power relay device 302 may relay the control instruction to power relay device 304, which may relay the control signal to power relay device 306, which in turn may relay the control signal to power relay device 308. Power relay device 308 may then reboot device 324, e.g., by cutting off the electric power provided to device 324 and providing the electric power to device 324 after the reboot period. In another example, device 322 may be powered-off, for example, by providing power relay device 302 with a control signal including an instruction portion having a value representing the power-off operation, and an identifier portion having the value “2”. Accordingly, power relay device 302 may relay the control instruction to power relay device 304, which may relay the control signal to power relay device 306. Both of power relay devices 304 and 306 may then power-off device 322, e.g., by cutting off the power supply to device 322.

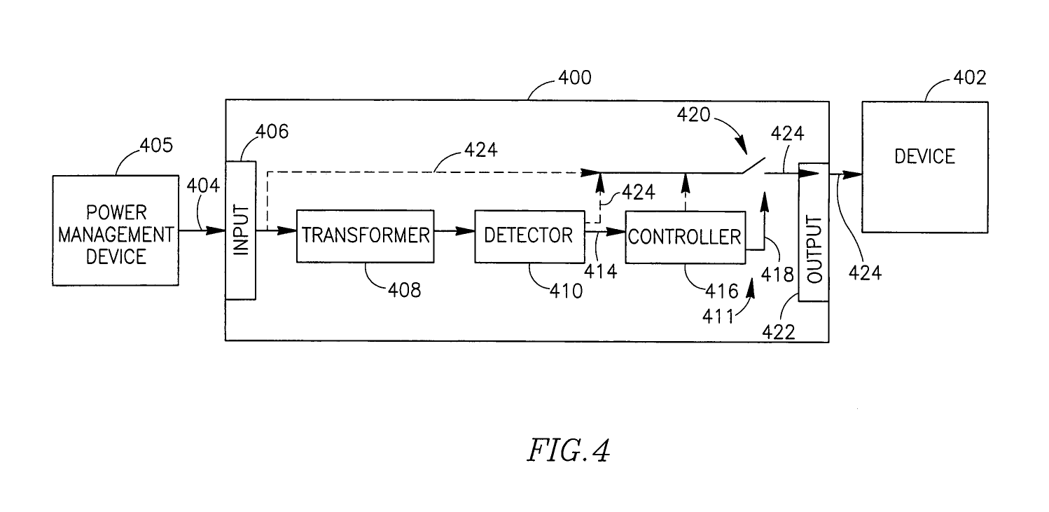

Reference is now made to FIG. 4, which schematically illustrates a power relay device 400, in accordance with some demonstrative embodiments.

In some embodiments, power relay device 400 may be capable of controllably providing electric power to a destination device 402 based on control data received over an input power signal 404, e.g., as described in detail below. In one embodiment, device 402 may perform the functionality of device 102 (FIG. 1).

In some embodiments, power relay device 400 may be implemented in any suitable form, configuration, design, size, and/or structure. In one embodiment, power relay device 400 may be implemented as a power over cable relay device, e.g., having a structure and/or dimensions similar to the power relay device described above with reference to FIGS. 1 and/or 2. In other embodiments, power relay device 400 may be implemented in any other suitable form, e.g., as part of a power relay device or switch having one or more attributes, e.g., size and/or structure, similar to conventional power relay devices and/or switches.

Power relay device 400 may include a power input 406 to receive input power signal 404, and a power output 422 to provide an output power signal 424 to destination device 402. In one embodiment, power input 406 may include any suitable power input or connector, e.g., as described above with reference to power input 130 (FIG. 1); and/or power output 422 may include any suitable power output or connector, e.g., as described above with reference to power output 124 (FIG. 1).

In some embodiments, power relay device 400 may be capable of controllably generating output power signal 424 based on input power signal 404, e.g., as described below.

In some embodiments, power signal 404 may be generated by any suitable power management device 405 to manage the supply of electric power to destination device 402. In one embodiment, power management device 405 may perform the functionality of device 104 (FIG. 1).

In some embodiments, power signal 404 may include a power signal adapted to carry data, e.g., in accordance with any suitable Power Line Communication (PLC) standard and/or protocol, Power Line Networking (PLN) standard and/or protocol, Power Line Telecom (PLT) standard and/or protocol, HomePlug Networks standard and/or protocol, HomePlug 1.0, HomePlug AV, HomePlug CC, INSTEON, X10, and/or any other suitable standard or protocol. The data carried by power signal 404 may include, for example, control data, e.g., similar to the control data provided by control signal 105 (FIG. 1). For example, the control data may include a “power-on” instruction to power-on destination device 402, a “power-off” instruction to power-off destination device 404, or a “reboot” instruction to reboot destination device 404 after a reboot time period, e.g., as described above.

In some embodiments, power relay device 400 may include a detector 410 to detect the control data carried by power signal 404, and generate a data signal 414 corresponding to the detected control data. For example detector 410 may include, or may be implemented as part of, a Physical Layer (PHY) module, e.g., a PHY according to any suitable PLC standard and/or protocol, PLN standard and/or protocol, PLT standard and/or protocol, HomePlug Networks standard and/or protocol, HomePlug 1.0, HomePlug AV, HomePlug CC, INSTEON, X10, and/or any other suitable standard or protocol or any other suitable protocol or standard. In other examples, detector 410 may include any other suitable filtering, separation, and/or detection module capable of generating data signal 414 based on power signal 404.

In some embodiments, power signal 424 may be provided by detector 410, e.g., if detector 410 includes a suitable PHY module adapted to provide a power output and a data output. In other embodiments, power signal 424 may include power signal 404 received from input 406, e.g., directly.

In some embodiments, power relay device 400 may include a control module 411 to controllably output electric signal 424 via power output 422, based on the control data of data signal 414, e.g., as described below.

In some embodiments, control module 411 may include a controller 416 and a switch 420 to controllably output signal 424 based on data signal 414, e.g., as described below.

In some embodiments, switch 420 may have a first mode, in which power output 422 is electrically connected to power input 406, to thereby output power signal 424; and a second mode, in which power output 422 is electrically disconnected from power input 406, to thereby prevent the output of power signal 424.

In some embodiments, controller 416 may receive signal 414, and control the operation of switch 420, e.g., using a signal 418, based on signal 414.

In some embodiments, signal 414 may include a “power-on” instruction, a “power-off” instruction, or a “reboot” instruction, e.g., as described above. For example, if signal 414 includes the “power-off” instruction, then controller 416 may generate signal 418 to cause switch 420 to switch to the second mode. If signal 414 includes the “power-on” instruction, then controller 416 may generate signal 418 to cause switch 420 to switch to the first mode. If signal 414 includes the “reboot” instruction, then controller 416 may generate signal 418 to cause switch 420 to switch to the second mode. Controller 416 may then generate signal 418 to cause switch 420 to switch to the first mode after a suitable time period, e.g., a time period defined by the reboot instruction or a predefined reboot time period.

In some embodiments, switch 420 may be at the first mode by default, such that power output 422 is electrically connected to power input 406, e.g., unless switch 420 is actively instructed by controller 416 to switch to the second mode.

In some embodiments, power relay device 400 may include a transformer 408 to transform input electric signal 404 into a DC signal provided to controller 416. In one embodiment, transformer 408 may include any suitable non-isolated transformer. In other embodiments, transformer may include any suitable isolated transformer.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A power relay device to controllably relay an electric power signal to a first device based on a control signal from a second device, the power relay device including:
a power input to receive an input electric signal;
a power output;
a control-signal receiver to receive the control signal from the second device, while the power relay device is galvanically separated from the second device; and
a control module to controllably output the electric signal via the power output based on the control signal.

2. The power relay device of claim 1, wherein the control module includes:
a switch having a first mode, in which the power output is electrically connected to the power input, and a second mode, in which the power output is electrically disconnected from the power input; and
a controller to control the operation of the switch based on the control signal.

3. The power relay device of claim 1 comprising a non-isolated transformer to transform an alternating-current signal of the input electric signal into a direct-current signal provided to the control module.

4. The power relay device of claim 1, wherein the control-signal receiver includes an optical receiver to receive the control signal in the form of an optical signal.

5. The power relay device of claim 4, wherein the optical receiver includes an infrared receiver to receive the control signal in the form of an infrared control signal.

6. The power relay device of claim 1, wherein the control-signal receiver is to receive the control signal via magnetic induction.

7. The power relay device of claim 1, wherein the control signal includes a wireless signal, and wherein the control-signal receiver includes a wireless receiver.

8. The power relay device of claim 1 comprising a control signal output to output the received control signal to another power relay device.

9. The power relay device of claim 8, wherein the control signal includes identification information identifying one or more intended power relay devices to utilize the control signal.

10. The power relay device of claim 9, wherein the control module is to controllably output the electrical signal based on the control signal, if the power relay device is included in the one or more intended power relay devices.

11. The power relay device of claim 9, wherein the control module is to relay the control signal to the control-signal output.

12. The power relay device of claim 8, wherein the control-signal output includes an infrared transmitter to transmit an infrared signal corresponding to the control signal.

13. The power relay device of claim 12, wherein the control-signal output includes a light emitting diode.

14. The power relay device of claim 1 including a single-input-single-output power relay device having a single power input and a single power output.

15. The power relay device of claim 1, wherein the control signal includes an instruction selected from the group consisting of a power-on instruction, a power-off instruction, and a reboot instruction.

16. The power relay device of claim 1, wherein the control signal includes an indication of an identifier to be assigned to the power relay device.

17. The power relay device of claim 1, wherein the length of the power relay device is less than about 150 mm, the width of the power relay device is less than about 100 mm, and the height of the power relay device is less than about 45 mm.

18. The power relay device of claim 1 including an output port, wherein the control module is to receive a request signal from the second device via the control-signal receiver, and, in response to the request signal to output response information.

19. A power relay device to controllably relay electric power, the power relay device including:
a power input to receive an input electric signal, wherein the input electric signal carries thereon control data;
a power output; and
a control module to controllably output the electric signal via the power output based on the control data.

20. The power relay device of claim 19, wherein the control module includes:
a switch having a first mode, in which the power output is electrically connected to the power input, and a second mode, in which the power output is electrically disconnected from the power input;
a detector to detect the control data from the input electric signal; and
a controller to control the operation of the switch based on the detected control data.

21. The power relay device of claim 19, wherein the control data includes an instruction selected from the group consisting of a power-on instruction, a power-off instruction, and a reboot instruction.

22. A system including:
a power relay device including:
a power input to receive an input electric signal from a power source;
a power output connectable to a destination device;
a control-signal receiver to receive a control signal from a power management device, while the power relay device is galvanically separated from the power management device; and
a control module to controllably output the electric signal via the power output based on the control signal.

23. The system of claim 22 including a connector interface to transfer the control signal from the power management device to the control-signal receiver.

24. The system of claim 22, wherein the power relay device includes a non-isolated transformer to transform the input electric signal into a direct-current signal provided to the control module.

25. The system of claim 22, wherein the control-signal receiver includes an optical receiver to receive the control signal in the form of an optical signal.

26. The system of claim 22, wherein the power relay device includes a control signal output to output the received control signal.

27. The system of claim 26 including another power relay device including a control-signal receiver to receive the outputted control signal.
